(19) United States
(12) Patent Application Publication
(10) Pub. No.: US 2015/0345320 A1
(43) Pub. Date: Dec. 3, 2015

(54) FAN CASE WITH AUXETIC LINER

(71) Applicant: United Technologies Corporation, Hartford, CT (US)

(72) Inventor: William H. Webb, Ellington, CT (US)

(73) Assignee: United Technologies Corporation, Hartford, CT (US)

(21) Appl. No.: 14/203,632

(22) Filed: Mar. 11, 2014

Related U.S. Application Data
(60) Provisional application No. 61/779,253, filed on Mar. 13, 2013.

(51) Int. Cl. F01D 11/12; C09J 5/00; F01D 25/24

(52) U.S. Cl. CPC F01D 11/127; F01D 25/24; C09J 5/00; F05D 2220/32; F05D 2230/60

(57) ABSTRACT

A case for fan includes a multilayer structure formed of cylindrical layers, including an outer shell and a liner layer. The liner layer is located radially inward from the shell. The liner layer is an auxetic material, which increases strength to increase effectiveness of case in a blade out condition.

### CROSS-REFERENCE TO RELATED APPLICATION(S)

The present application claims priority to U.S. Provisional Patent Application Serial No. 61/779,253 entitled FAN CASE WITH AUXETIC LINER filed Mar. 13, 2013, which is hereby incorporated by reference in its entirety.

### BACKGROUND

In a blade out event, one or more fan blades or portions thereof in a turbine engine may be caused to be released, for example, as a result of the ingestion of a foreign object. In such an event, the released fan blade must be contained so as not to penetrate the fan case. In addition, after a blade out event the fan case must retain its structural integrity while the jet engine shuts down in order to prevent further potentially catastrophic damage. Despite these significant ballistic requirements on the fan case, the fan case is a large structure which contributes significantly to the overall weight and drag of the engine. Among the many challenges faced by a person of skill in the art is how to balance the ballistic requirements of the fan case with the competing weight, cost and size constraints. Thus, a high strength fan containment case is of value.

### SUMMARY

A containment case includes a multi-layer cylindrical containment structure, wherein at least one layer is an auxetic material.

A method of forming a fan case includes positioning a ballistic liner made of auxetic material radially inward from a fan case shell; and connecting the ballistic liner to the fan case shell.

### BRIEF DESCRIPTION OF THE DRAWINGS

FIG. 1 schematically illustrates an example gas turbine engine that includes a fan section, a compressor section, a combustor section and a turbine section.

FIG. 2A is a perspective view of a fan case.

FIG. 2B is a cross sectional view of the fan case of FIG. 2A.

FIG. 2C is close up view of a portion of FIG. 2B.

### DETAILED DESCRIPTION

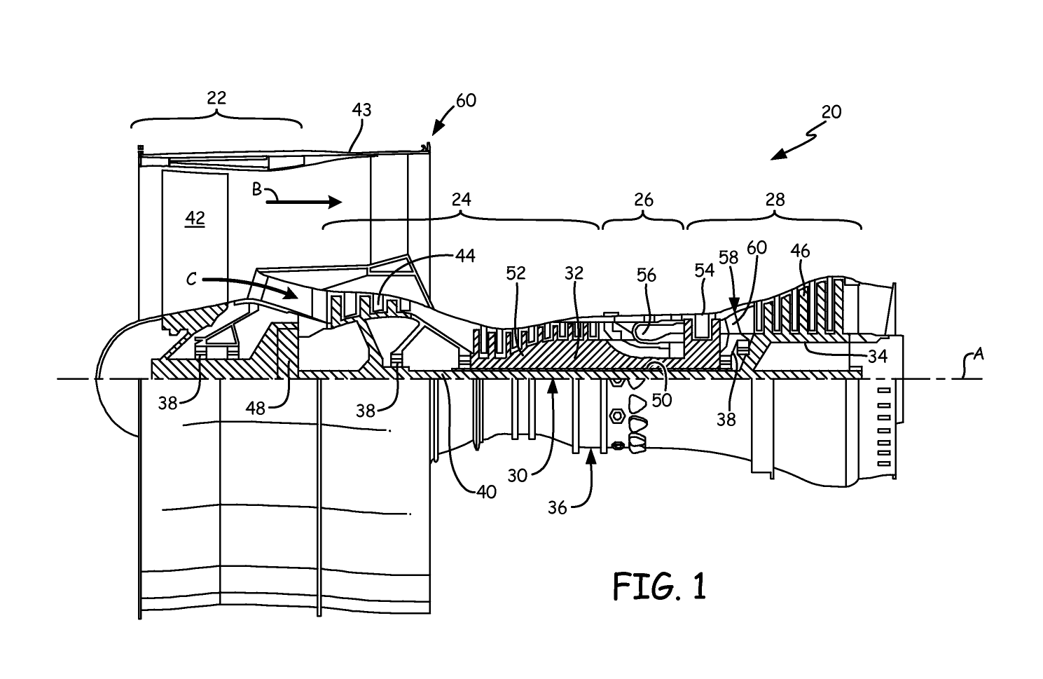

FIG. 1 schematically illustrates an example gas turbine engine 20 that includes fan section 22, compressor section 24, combustor section 26 and turbine section 28. Alternative engines might include an augmenter section (not shown) among other systems or features. Fan section 22 drives air along bypass flow path B while compressor section 24 draws air in along core flow path C where air is compressed and communicated to combustor section 26. In combustor section 26, air is mixed with fuel and ignited to generate a high pressure exhaust gas stream that expands through turbine section 28 where energy is extracted and utilized to drive fan section 22 and compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section. It should be further understood that the disclosed non-limiting embodiment provides generally a ballistic barrier that is suitable for many types of rotating or rotary machines as known to those of ordinary skill in the art.

The example engine 20 generally includes low speed spool 30 and high speed spool 32 mounted for rotation about an engine central longitudinal axis A relative to an engine static structure 36 via several bearing systems 38. It should be understood that various bearing systems 38 at various locations may alternatively or additionally be provided.

Low speed spool 30 generally includes inner shaft 40 that connects fan 41 and low pressure (or first) compressor section 44 to low pressure (or first) turbine section 46. Inner shaft 40 drives fan 41 through a speed change device, such as geared architecture 48, to drive fan 41 at a lower speed than low speed spool 30. High-speed spool 32 includes outer shaft 50 that interconnects high pressure (or second) compressor section 52 and high pressure (or second) turbine section 54. Inner shaft 40 and outer shaft 50 are concentric and rotate via bearing systems 38 about engine central longitudinal axis A.

Combustor 56 is arranged between high pressure compressor 52 and high pressure turbine 54. In one example, high pressure turbine 54 includes at least two stages to provide a double stage high pressure turbine 54. In another example, high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of low pressure turbine 46 as related to the pressure measured at the outlet of low pressure turbine 46 prior to an exhaust nozzle.

Mid-turbine frame 58 of engine static structure 36 is arranged generally between high pressure turbine 54 and low pressure turbine 46. Mid-turbine frame 58 further supports bearing systems 38 in turbine section 28 as well as setting airflow entering low pressure turbine 46.

The core airflow C is compressed by low pressure compressor 44 and then by high pressure compressor 52, mixed with fuel and ignited in combustor 56 to produce high speed exhaust gases, and then expanded through high pressure turbine 54 and low pressure turbine 46. Mid-turbine frame 58 includes vanes 60, which are in the core airflow path and function as an inlet guide vane for low pressure turbine 46. Utilizing vane 60 of mid-turbine frame 58 as the inlet guide vane for low pressure turbine 46 decreases the length of low pressure turbine 46 without increasing the axial length of mid-turbine frame 58. Reducing or eliminating the number of vanes in low pressure turbine 46 shortens the axial length of turbine section 28. Thus, the compactness of gas turbine engine 20 is increased and a higher power density may be achieved.

The disclosed gas turbine engine 20 in one example is a high-bypass geared aircraft engine. In a further example, gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, gas turbine engine 20 includes a bypass ratio greater than about ten (10:1) and the fan diameter is significantly larger than an outer diameter of low pressure compressor 44. It should be understood, however, that the above parameters are only exemplary of one embodiment of a gas turbine engine including a geared architecture and that the present disclosure is applicable to other gas turbine engines.

A significant amount of thrust is provided by bypass flow B due to the high bypass ratio. Fan section 22 of engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram° R)/518.7° R]^{0.5}. The “Low corrected fan tip speed”, as disclosed herein according to one non-limiting embodiment, is less than about 1150 ft/second.

The example gas turbine engine includes fan 41 that comprises in one non-limiting embodiment less than about twenty-six fan blades 42 and fan case 43 surrounding fan 41. In another non-limiting embodiment, fan section 22 includes less than about twenty fan blades 42. Moreover, in one disclosed embodiment low pressure turbine 46 includes no more than about six turbine rotors schematically indicated at 34. In another non-limiting example embodiment low pressure turbine 46 includes about three turbine rotors. A ratio between number of fan blades 42 and the number of low pressure turbine rotors is between about 3.3 and about 8.6. The example low pressure turbine 46 provides the driving power to rotate fan section 22 and therefore the relationship between the number of turbine rotors 34 in low pressure turbine 46 and number of blades 42 in fan section 22 disclose an example gas turbine engine 20 with increased power transfer efficiency.

In a turbofan engine, lighter components generally lead to more efficient performance. If less energy is expended moving internal engine parts, more energy is available for useful work. At the same time, the components themselves must be strong enough to withstand forces typical for the operating environment and performance envelope. Safety considerations based on the frequency and/or severity of possible failure will often dictate that the engine components also be able to withstand certain atypical, yet foreseeable events as well. Because stronger components are often heavier and/or more expensive, a balance must be struck between efficiency, safety, and cost.

Few locations in an aircraft are more representative of efforts to optimize the balance between efficiency, safety, and cost than engine 20. While lighter materials are preferable to improve efficiency, the high risk of severe consequences from engine damage will require that engine 20 be made of components having additional margins of safety. Fiber composites typically have low weight, and three-dimensional weaving of the composites can greatly increase strength in the thickness direction.

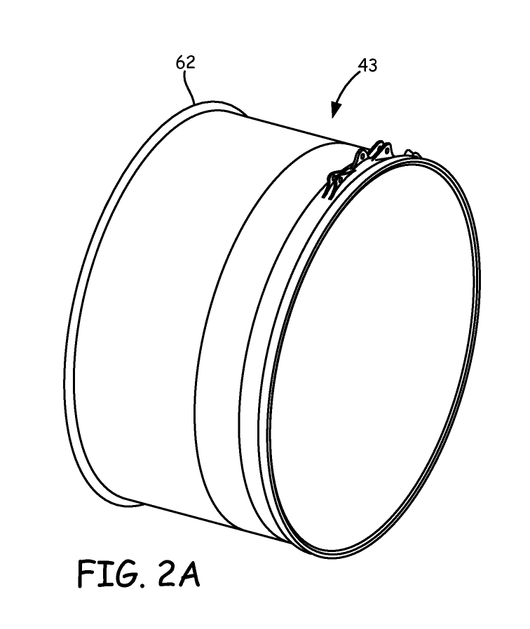

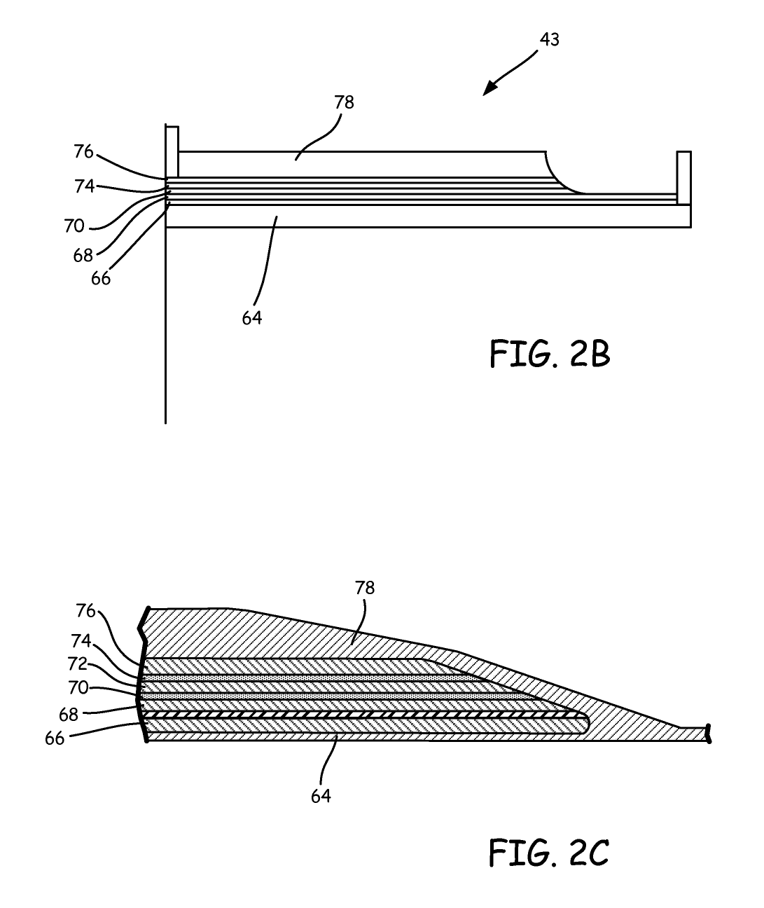

FIG. 2A is a perspective view of fan case 43. FIG. 2B is a cross sectional view of a portion of fan case 43, and FIG. 2C is close up view of a portion of fan case 43.

Fan case 43 is a multi-layer containment structure for fan 41, and includes inlet 62, rub strip 64, fiberglass septum 66, wedge honeycomb 68, conformable liner 70, adhesive 72, conformable layer 74, ballistic liner 76 and fan case shell 78. Each of rub strip 64, fiberglass septum 66, wedge honeycomb 68, conformable liner 70, conformable layer 74, ballistic liner 76 and fan case shell 78 is cylindrical in shape.

Rub strip 64 is a layer on which fan blade 42 tips (not shown) can rub when fan 41 is operating. Radially outward of rub strip 64 is fiberglass septum 66, which is a fiberglass structure to which rub strip 64 and honeycomb layer 68 adhere. Radially outward from fiberglass septum 66 is wedge honeycomb layer 68, which acts to provide rigidity and noise control. Radially outward from wedge honeycomb layer 68 is conformable liner 70 and conformable layer 74. Conformable liner 70 and conformable layer 74 act to prevent ovalization and distortion of fan case 43 throughout expansion and contraction during normal engine operations, and could be any material that makes thermal adjustments, for example, a metallic layer, shaped memory alloy or another mechanical set up. Conformable layer 74 connects to conformable liner 70 and to ballistic liner 76 with adhesive 72. Radially outward from conformable layer 74 is ballistic liner 76. Radially outward of ballistic liner 76 is fan case shell 78, which can be a composite or other rigid material. Layers 64, 66, 68, 70, 74, 76, 78 can be connected through use of adhesive such as epoxy or any other method know in the art.

Fan case 43 can be formed by positioning ballistic liner 76 radially inward from fan case shell 78 and connecting ballistic liner 76 to fan case shell 78. Additionally, conformable layer 74 can be connected radially inward to ballistic liner 76; conformable liner 70 can be connected radially inward to conformable layer 74; wedge honeycomb 68 can be connected radially inward to conformable liner 70; fiberglass septum 66 can be connected radially inward to wedge honeycomb 68; and rub strip 64 can be connected radially inward to the fiberglass septum 66. Conformable layer 74 can be connected to ballistic liner 76 and to conformable liner 70 with adhesive.

Ballistic liner 76 acts to contain fan 41 and/or fan blades 42 and is made of an auxetic material. Auxetic materials are materials that have a negative Poisson's ratio. When auxetic materials are stretched, they flex and become thicker perpendicular to the applied force. This occurs due to their hinge-like structures, which flex when stretched. Typically, auxetic materials have low density, allowing the hinge-like areas of auxetic microstructures to flex. Examples of suitable auxetic materials include a bi-directional auxetic weave such at Zetix, manufactured by Auxetics Technologies, Ltd.

Ballistic liner 76 can be made of auxetic material woven or formed into cylindrical liner shape by other methods. Examples of weaves include an open weave pattern and blended weaves, for example, an open circular weave of traditional Kevlar type reinforcement in the hoop direction with auxetic material in an angled weave to interconnect and maintain position of the hoop materials, a para-aramid ausetic blend, an aramid auxetic blend or polyamide auxetic blend. An open weave pattern may reduce fan blade tip noise, as the auxtetic material would close up the open weave holes when hit. In a blended weave, auxetic materials would bring reinforcing materials closer together when hit, fighting the effects of the strike.

Auxetic materics could be incorporated into ballistic liner 76 in other fashions as well, for example, an auxetic material could encase or be bonded to a surface of a traditional ballistic liner. Other embodiments could have a piecewise linear structure with panels connecting via auxetic materials to stiffen a modular structure. In yet another embodiment, auxetic material or auxetic foam materials could be formed via a molding process to create a final form.

By forming ballistic liner 76 with an auxetic material, ballistic liner 76 can perform as a strong and effective but lightweight liner to contain fan 41 components in the case of a failure and/or blade out condition. The properties of auxetic materials ensures ballistic liner 76 would get thicker when stretched, increasing effectiveness to an impact condition while the low density of auxetic materials would allow for a reduction in weight as compared to past ballistic liners. Ballistic liner 76 of auxetic material would allow for a fan case 43 that could provide noise reduction, increased impact absorption capabilities and an overall reduction in weight.

A fan case includes a shell; and a ballistic liner radially inward from the shell, wherein the ballistic liner is an auxetic material. Additional and/or alternative embodiments include the ballistic liner further comprising a non-auxetic material; the ballistic liner being woven; the ballistic liner being a woven blend of an auxetic material and a non-auxetic material; the ballistic liner being an open weave; the shell being a composite the fan case further comprising a conformable layer radially inward from the ballistic liner, a conformable liner radially inward from the conformable layer, a wedge honeycomb radially inward from the conformable liner, a fiberglass septum radially inward from the wedge honeycomb and a rub strip radially inward from the fiberglass septum; and/or the conformable layer connecting to the ballistic liner and to the conformable liner with adhesive.

A containment case includes a multi-layer cylindrical containment structure, wherein at least one layer is an auxetic material. Additional and/or alternative embodiments include the cylindrical containment structure comprising a rub strip layer, a noise control layer radially outside of the cylindrical rub strip, a distortion preventing layer radially outside of the noise control layer, a containment layer radially outside of the distortion preventing layer, and a shell radially outise of the containment layer; the containment layer comprising an auxetic material; the containment layer further comprising a non-auxetic material; the noise control layer comprising wedge honeycomb; the distortion preventing layer comprising a conformable liner, and a conformable layer radially outside of the conformable liner; a fiberglass septum between the rub strip layer and the noise control layer; the containment case being a fan case; and/or the auxetic material being a woven material.

A method of forming a fan case includes positioning a ballistic liner made of auxetic material radially inward from a fan case shell; and connecting the ballistic liner to the fan case shell. Additional and/or alternative embodiments include connecting a conformable layer radially inward to the ballistic liner; connecting a conformable liner radially inward to the conformable layer; connecting a wedge honeycomb radially inward to the conformable liner; connecting a fiberglass septum radially inward to the wedge honeycomb; and connecting a rub strip radially inward to the fiberglass septum; and/or the conformable layer being connected to the ballistic liner and to the conformable liner with adhesive.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fan case comprising:
a shell; and
a ballistic liner radially inward from the shell, wherein the ballistic liner is an auxetic material

2. The fan case of claim 1, the ballistic liner further comprising a non-auxetic material.

3. The fan case of claim 1, wherein the ballistic liner is woven.

4. The fan case of claim 3, wherein the ballistic liner is a woven blend of an auxetic material and a non-auxetic material.

5. The fan case of claim 3, wherein the ballistic liner is an open weave.

6. The fan case of claim 1, wherein the shell is a composite.

7. The fan case of claim 1, and further comprising:
a conformable layer radially inward from the ballistic liner;
a conformable liner radially inward from the conformable layer;
a wedge honeycomb radially inward from the conformable liner;
a fiberglass septum radially inward from the wedge honeycomb; and
a rub strip radially inward from the fiberglass septum.

8. The fan case of claim 7, wherein the conformable layer connects to the ballistic liner and to the conformable liner with adhesive.

9. A containment case comprising:
a multi-layer cylindrical containment structure, wherein at least one layer is an auxetic material.

10. The containment case of claim 9, wherein the cylindrical containment structure comprises:
a rub strip layer;
a noise control layer radially outside of the cylindrical rub strip;
a distortion preventing layer radially outside of the noise control layer;
a containment layer radially outside of the distortion preventing layer; and
a shell radially outise of the containment layer.

11. The containment case of claim 10, wherein the containment layer comprises an auxetic material.

12. The containment case of claim 11, wherein the containment layer further comprises a non-auxetic material.

13. The containment case of claim 10, wherein the noise control layer comprises wedge honeycomb.

14. The containment case of claim 10, wherein the distortion preventing layer comprises:
a conformable liner; and
a conformable layer radially outside of the conformable liner.

15. The containment case of claim 10, and further comprising:
a fiberglass septum between the rub strip layer and the noise control layer.

16. The containment case of claim 9, wherein the containment case is a fan case.

17. The containment case of claim 9, wherein the auxetic material is a woven material.

18. A method of forming a fan case, the method comprising:
positioning a ballistic liner made of auxetic material radially inward from a fan case shell; and
connecting the ballistic liner to the fan case shell.

19. The method of claim 18, and further comprising:
connecting a conformable layer radially inward to the ballistic liner;
connecting a conformable liner radially inward to the conformable layer;
connecting a wedge honeycomb radially inward to the conformable liner;
connecting a fiberglass septum radially inward to the wedge honeycomb; and
connecting a rub strip radially inward to the fiberglass septum.

20. The method of claim 18, wherein the conformable layer is connected to the ballistic liner and to the conformable liner with adhesive.
